(19) United States
(12) Patent Application Publication
(10) Pub. No.: US 2017/0043523 A1
(43) Pub. Date: Feb. 16, 2017

(54) Thermoplastic Shell Assembly Formed Integrally by Embedding and Sticking and Method for Manufacturing the Shell Assembly

(71) Applicant: Chih-Chia Wei, Taichung City (TW)

(72) Inventor: Chih-Chia Wei, Taichung City (TW)

(21) Appl. No.: 14/825,229

(22) Filed: Aug. 13, 2015

(51) Int. Cl. B29C 65/02

(52) U.S. Cl. CPC B29C 65/02

(57) ABSTRACT

A method is used for manufacturing a shell assembly which includes a metallic shell, a plastic inner layer, and at least one plastic ornamental piece. The at least one plastic ornamental piece and the plastic inner layer are embedded into and stuck to the metallic shell, and are combined together, so that the metallic shell, the plastic inner layer and the at least one plastic ornamental piece are combined integrally.

### BACKGROUND OF THE INVENTION

1. Field of the Invention

The present invention relates to a thermoplastic shell assembly formed integrally by embedding and sticking and a method for manufacturing the shell assembly.

2. Description of the Related Art

A conventional metallic shell assembly is not formed integrally and is divided into multiple parts which are initially manufactured individually and are then combined together to construct the metallic shell assembly. In fabrication, a metallic shell blank is processed by a CNC working procedure to form at least one slot. Then, the metallic shell blank is processed by an anodizing treatment. Then, the metallic shell blank is combined with a plastic material by an injection process to form the metallic shell assembly. However, the conventional metallic shell assembly has a higher cost of fabrication. In addition, the working cutter is worn out during a long-term utilization, thereby decreasing the working precision, thereby decreasing the quality of the product, and thereby easily producing flawed products. Further, the chemical agents remaining after the anodizing treatment will erode the metal and the plastic material.

### BRIEF SUMMARY OF THE INVENTION

In accordance with the present invention, there is provided a shell assembly comprising a metallic shell, a plastic inner layer, and at least one plastic ornamental piece. The metallic shell is provided with at least one slot. The metallic shell has an inner surface provided with at least one protruding arcuate face aligning with the at least one slot. The metallic shell is processed by an anodizing treatment. The at least one protruding arcuate face of the metallic shell is processed by a CNC working procedure to have an insulating function. The inner surface of the metallic shell is provided with at least one worked portion which is processed by an etching process or a laser engraving working procedure. The at least one worked portion of the metallic shell is coated with a glue. The at least one slot of the metallic shell is provided with a plurality of through holes equally spaced from each other. The plastic inner layer is provided with a plurality of apertures aligning with the through holes of the metallic shell. The inner surface of the metallic shell is coated with a thermosol. The plastic inner layer is placed in the inner surface of the metallic shell and is combined with the thermosol. The at least one plastic ornamental piece is provided with a plurality of connecting legs aligning with the through holes of the metallic shell. The at least one plastic ornamental piece is coated with a liquid silicone. The connecting legs of the at least one plastic ornamental piece are inserted through the through holes of the at least one slot of the metallic shell into the apertures of the plastic inner layer and slightly protrude outward from the apertures of the plastic inner layer. The connecting legs of the at least one plastic ornamental piece are heated and pressed by a heating mold so that the at least one plastic ornamental piece is combined integrally with the plastic inner layer.

In accordance with the present invention, there is also provided a method for manufacturing a shell assembly, comprising a first step, a second step, a third step, a fourth step and a fifth step. The first step includes placing a metallic plate in a lower die which has a periphery provided with an annular groove for mounting a separation washer which has a top higher than a top plane of the lower die, placing the metallic plate on the top of the separation washer, moving an upper die downward to apply a determined pressure on the metallic plate, heating the lower die and the upper die by a heating device to reach a proper temperature so as to deform the metallic plate, delivering a high pressure gas through the upper die to blow and press the metallic plate into a lower die cavity of the lower die so as to form a metallic shell, moving the upper die upward to open the lower die, removing the metallic shell from the lower die cavity of the lower die, and trimming the metallic shell to remove a residual part so as to obtain an integrally formed product of the metallic shell. The second step includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, coating a glue on the at least one worked portion of the metallic shell, coating a thermosol on the inner surface of the metallic shell, and placing a plastic inner layer in the inner surface of the metallic shell to combine with the thermosol. The third step includes coating a liquid silicone in the at least one slot of the metallic shell. The fourth step includes forming a plurality of through holes in the at least one slot of the metallic shell, forming a plurality of apertures in the plastic inner layer, inserting a plurality of connecting legs of at least one plastic ornamental piece through the through holes of the at least one slot of the metallic shell into the apertures of the plastic inner layer and letting the connecting legs of the at least one plastic ornamental piece protrude outward from the apertures of the plastic inner layer, and heating and pressing the connecting legs of the at least one plastic ornamental piece by a heating mold to integrally combine the at least one plastic ornamental piece with the plastic inner layer. The fifth step includes finishing a shell assembly which is an integral combination of the metallic shell, the plastic inner layer and the at least one plastic ornamental piece.

According to the primary advantage of the present invention, the at least one plastic ornamental piece and the plastic inner layer are embedded into and stuck to the metallic shell, and are combined together, so that the metallic shell, the plastic inner layer and the at least one plastic ornamental piece are combined integrally.

According to another advantage of the present invention, the shell assembly is made easily and conveniently to reduce the cost of fabrication.

According to a further advantage of the present invention, the shell assembly has an enhanced working precision to increase the quality of the product and to decrease the possibility of producing flawed products.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view showing a metallic plate being placed on the top of a separation washer.

FIG. 2 is a schematic operational view of FIG. 1.

FIG. 3 is a schematic operational view of FIG. 2.

FIG. 4 is a schematic operational view of FIG. 3.

FIG. 5 is a cross-sectional view showing each of the slots of the metallic shell being coated with a liquid silicone.

FIG. 6 is a cross-sectional view showing the connecting legs of each of the plastic ornamental pieces being inserted through the through holes of the slots of the metallic shell.

FIG. 7 is a schematic operational view of FIG. 6.

FIG. 8 is a schematic operational view of FIG. 7.

FIG. 9 is a perspective view of a metallic shell of a shell assembly in accordance with the preferred embodiment of the present invention.

FIG. 10 is a perspective view of the shell assembly in accordance with the preferred embodiment of the present invention.

FIG. 11 is an exploded perspective view of the shell assembly in accordance with the preferred embodiment of the present invention.

FIG. 12 is a longitudinal cross-sectional view of the shell assembly in accordance with the preferred embodiment of the present invention.

FIG. 13 is a transverse cross-sectional view of the shell assembly in accordance with the preferred embodiment of the present invention.

FIG. 14 is a flow chart of a method for manufacturing a shell assembly in accordance with the preferred embodiment of the present invention.

### DETAILED DESCRIPTION OF THE INVENTION

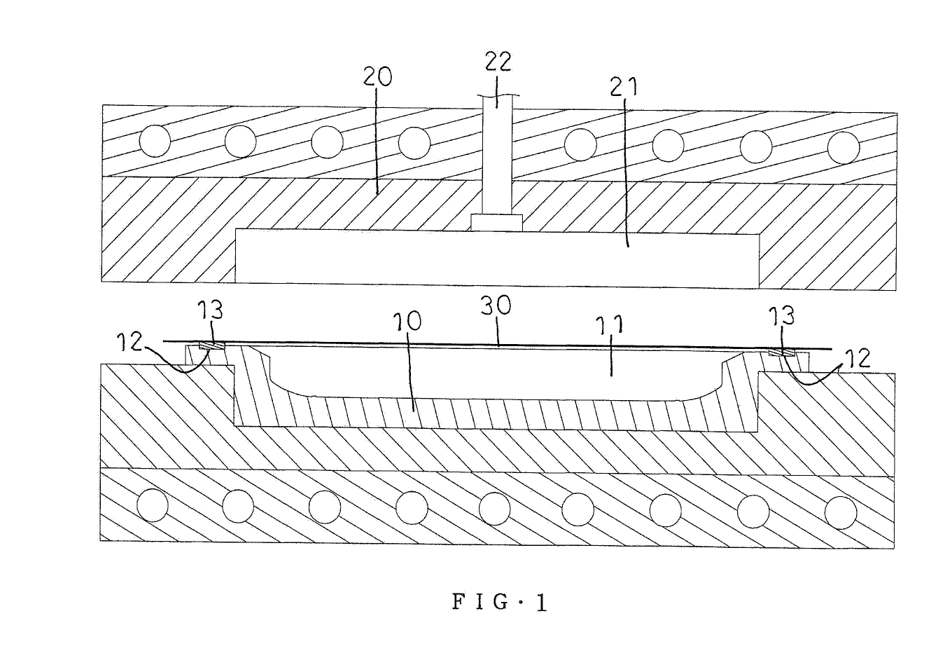

Referring to the drawings and initially to FIGS. 1-8, a method in accordance with the preferred embodiment of the present invention comprises providing a lower die 10, an upper die 20, a metallic plate 30, a plastic inner layer 40, and two plastic ornamental pieces 50.

The lower die 10 has an interior provided with a lower die cavity 11 and has a periphery provided with an annular groove 12 for mounting a separation washer 13 which has a top higher than a top plane of the lower die 10.

The upper die 20 has an interior provided with an upper die cavity 21 aligning with the lower die cavity 11 of the lower die 10 and has a central portion provided with an input pipe 22 for delivering a high pressure gas.

The metallic plate 30 is slightly larger than the lower die cavity 11 of the lower die 10 and is placed on the top of the separation washer 13 of the lower die 10 as shown in FIG. 1.

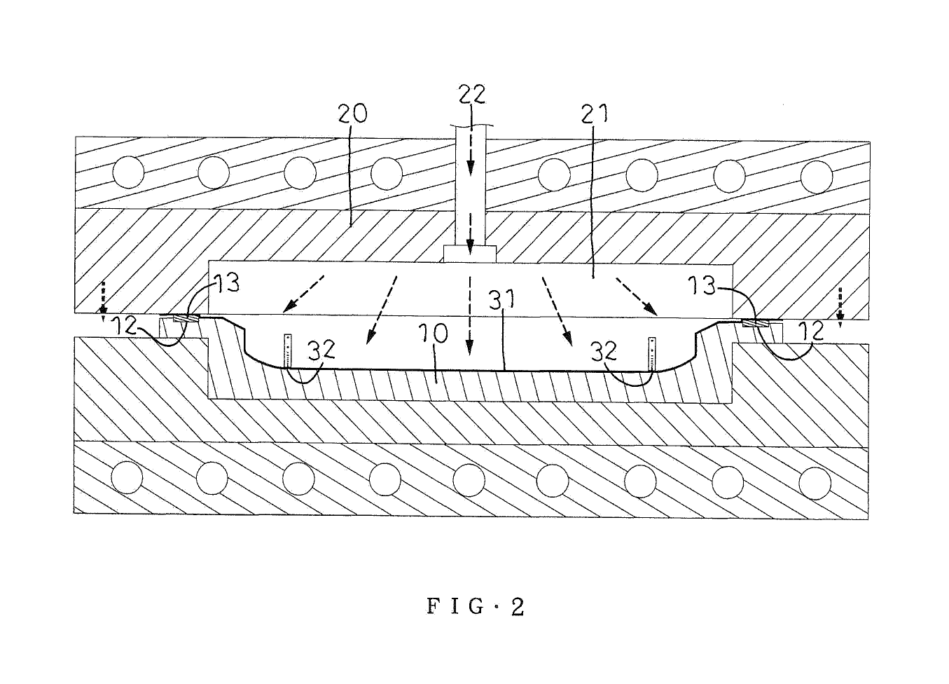

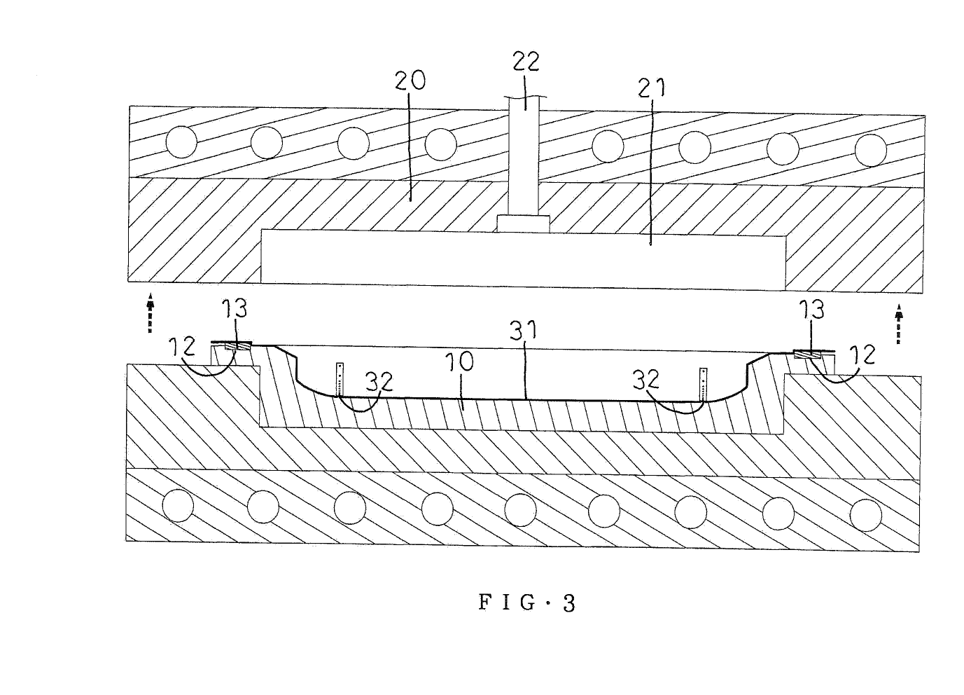

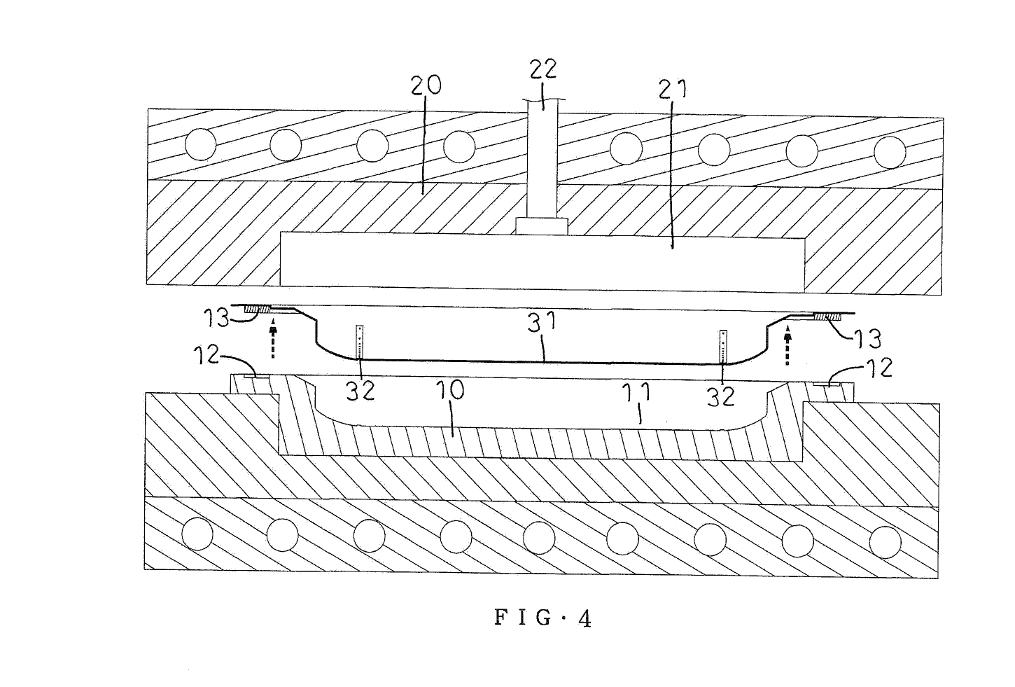

When the upper die 20 is moved downward to abut and close the lower die 10, the metallic plate 30 is subjected to a determined pressure. Then, the lower die 10 and the upper die 20 are heated by a heating device (not shown) to reach a proper temperature so as to deform the metallic plate 30. Then, the high pressure gas is delivered through the input pipe 22 into the upper die cavity 21 of the upper die 20 to blow and press the metallic plate 30 into the lower die cavity 11 of the lower die 10 as shown in FIG. 2 so as to form a metallic shell 31. Then, the upper die 20 is moved upward to open the lower die 10 as shown in FIG. 3. Then, the metallic shell 31 is removed from the lower die cavity 11 of the lower die 10 as shown in FIG. 4. At this time, the metallic plate 30 is separated from the lower die 10 by the separation washer 13 so that the metallic plate 30 will not be adhered to the lower die cavity 11 of the lower die 10 and is easily removed from the lower die cavity 11 of the lower die 10. Then, the metallic shell 31 is trimmed to remove the residual part so as to obtain an integrally formed product of the metallic shell 31. The metallic shell 31 has an outer surface provided with two slots 32 located at upper and lower portions of the metallic shell 31. The metallic shell 31 has an inner surface provided with two protruding arcuate faces 321 aligning with the slots 32 respectively. The metallic shell 31 is initially processed by an anodizing treatment. Then, the two arcuate faces 321 of the metallic shell 31 are processed by a CNC working procedure to have an insulating function. The inner surface of the metallic shell 31 is provided with a plurality of worked portions 322 which are processed by an etching process or a laser engraving working procedure. Then, the worked portions 322 of the metallic shell 31 are coated with a glue 323. Each of the slots 32 of the metallic shell 31 is provided with a plurality of through holes 33 equally spaced from each other.

The plastic inner layer 40 is provided with a plurality of apertures 41 aligning with the through holes 33 of the metallic shell 31. The inner surface of the metallic shell 31 is initially coated with a thermosol. Then, the plastic inner layer 40 is placed in the inner surface of the metallic shell 31 and is combined with the thermosol.

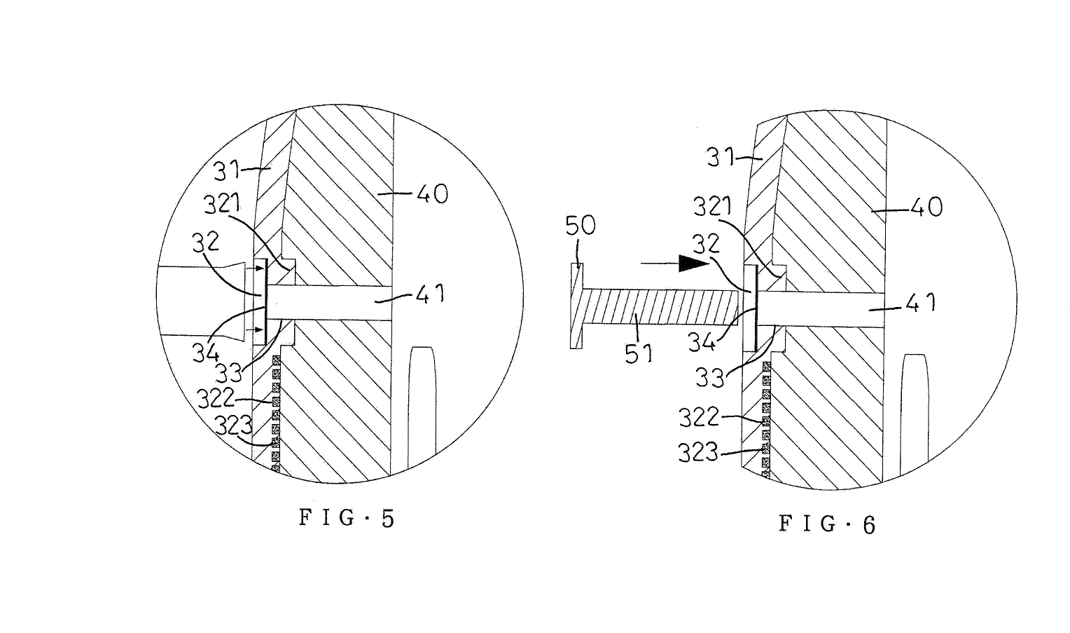

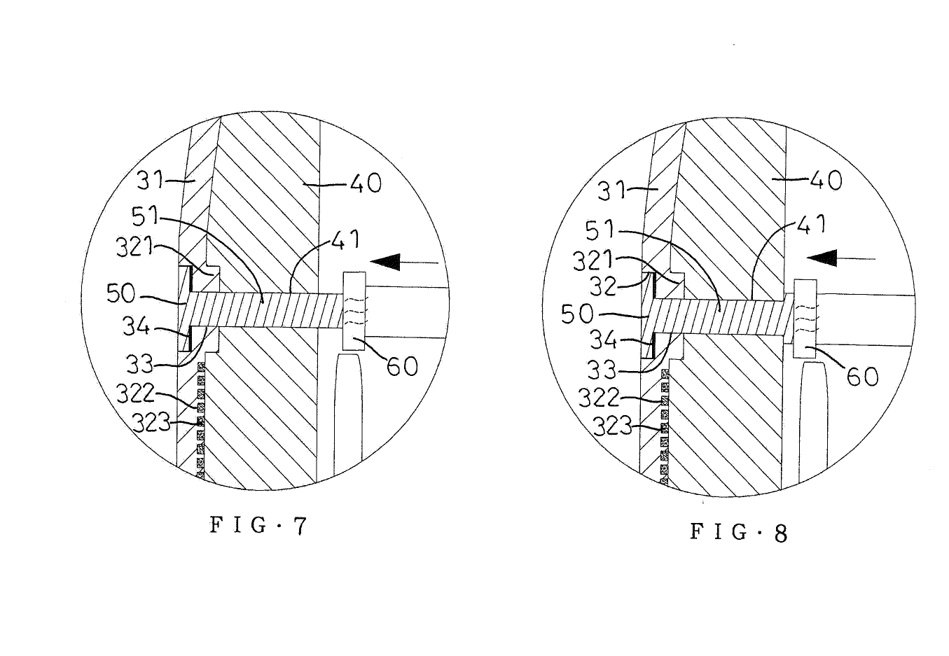

Each of the plastic ornamental pieces 50 is provided with a plurality of connecting legs 51 aligning with the through holes 33 of the metallic shell 31. Each of the slots 32 of the metallic shell 31 is initially coated with a liquid silicone 34 as shown in FIG. 5. Then, the connecting legs 51 of each of the plastic ornamental pieces 50 are inserted through the through holes 33 of the slots 32 of the metallic shell 31 as shown in FIG. 6 into the apertures 41 of the plastic inner layer 40 and slightly protrude outward from the apertures 41 of the plastic inner layer 40 as shown in FIG. 7. Then, the connecting legs 51 of each of the plastic ornamental pieces 50 are heated and pressed by a heating mold 60 as shown in FIG. 8 so that each of the plastic ornamental pieces 50 is combined integrally with the plastic inner layer 40. In such a manner, the plastic ornamental pieces 50 and the plastic inner layer 40 are embedded into and stuck to the metallic shell 31, and are combined together, so that the metallic shell 31, the plastic inner layer 40 and the plastic ornamental pieces 50 are combined integrally.

In the preferred embodiment of the present invention, the plastic inner layer 40 and the plastic ornamental pieces 50 are made of plastics. In addition, the metallic shell 31 is integrally formed by a thermoplastic molding process.

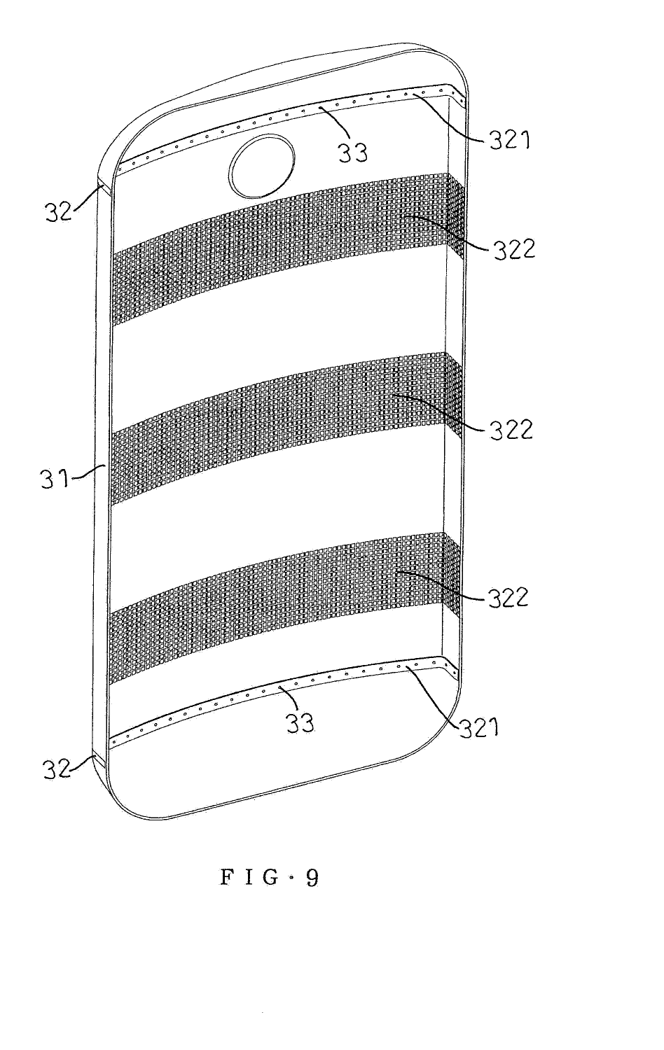

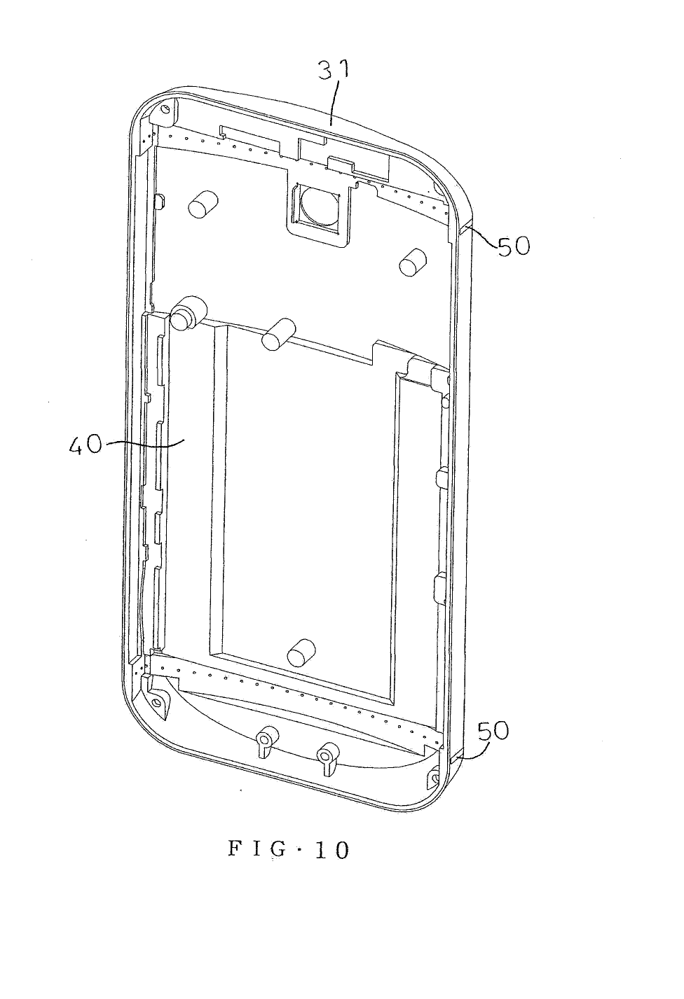

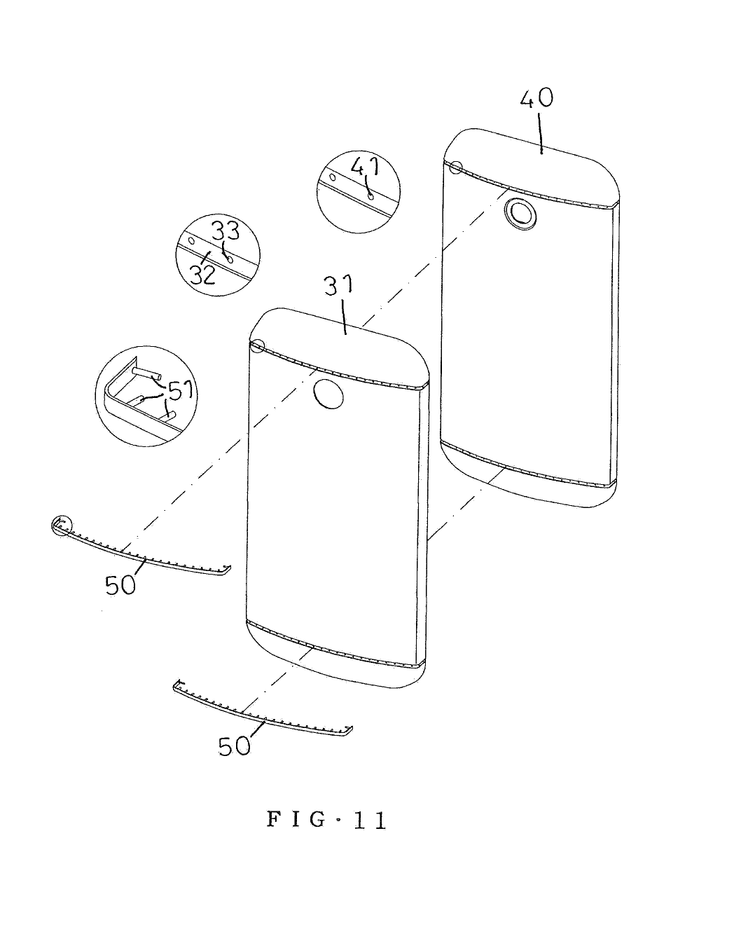

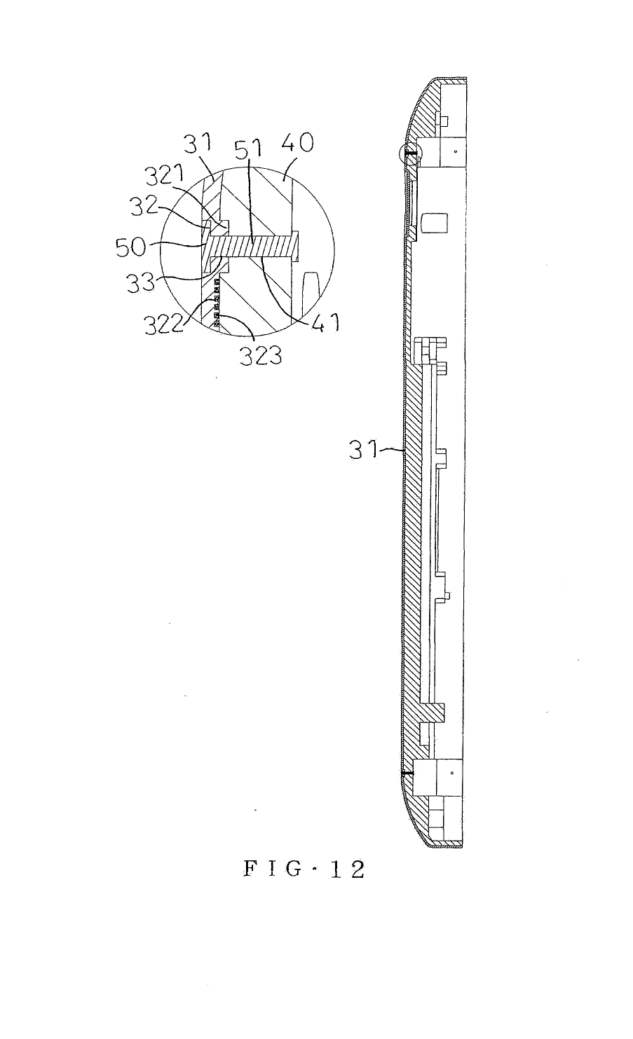

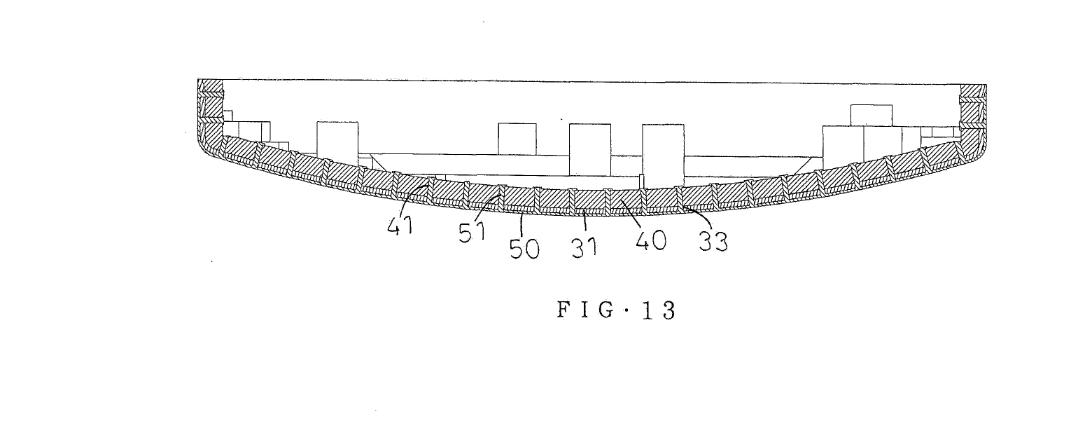

Referring to FIGS. 9-13 with reference to 1-8, a shell assembly in accordance with the preferred embodiment of the present invention comprises a metallic shell 31, a plastic inner layer 40, and at least one plastic ornamental piece 50.

The metallic shell 31 is provided with at least one slot 32. The metallic shell 31 has an inner surface provided with at least one protruding arcuate face 321 aligning with the at least one slot 32. The metallic shell 31 is processed by an anodizing treatment. The at least one protruding arcuate face 321 of the metallic shell 31 is processed by a CNC working procedure to have an insulating function. The inner surface of the metallic shell 31 is provided with at least one worked portion 322 which is processed by an etching process or a laser engraving working procedure. The at least one worked portion 322 of the metallic shell 31 is coated with a glue 323. The at least one slot 32 of the metallic shell 31 is provided with a plurality of through holes 33 equally spaced from each other.

The plastic inner layer 40 is provided with a plurality of apertures 41 aligning with the through holes 33 of the metallic shell 31. The inner surface of the metallic shell 31 is coated with a thermosol. The plastic inner layer 40 is placed in the inner surface of the metallic shell 31 and is combined with the thermosol.

The at least one plastic ornamental piece 50 is provided with a plurality of connecting legs 51 aligning with the through holes 33 of the metallic shell 31. The at least one plastic ornamental piece 50 is coated with a liquid silicone 34. The connecting legs 51 of the at least one plastic ornamental piece 50 are inserted through the through holes 33 of the at least one slot 32 of the metallic shell 31 into the apertures 41 of the plastic inner layer 40 and slightly protrude outward from the apertures 41 of the plastic inner layer 40. The connecting legs 51 of the at least one plastic ornamental piece 50 are heated and pressed by a heating mold 60 so that the at least one plastic ornamental piece 50 is combined integrally with the plastic inner layer 40.

Accordingly, the at least one plastic ornamental piece 50 and the plastic inner layer 40 are embedded into and stuck to the metallic shell 31, and are combined together, so that the metallic shell 31, the plastic inner layer 40 and the at least one plastic ornamental piece 50 are combined integrally. In addition, the shell assembly is made easily and conveniently to reduce the cost of fabrication. Further, the shell assembly has an enhanced working precision to increase the quality of the product and to decrease the possibility of producing flawed products.

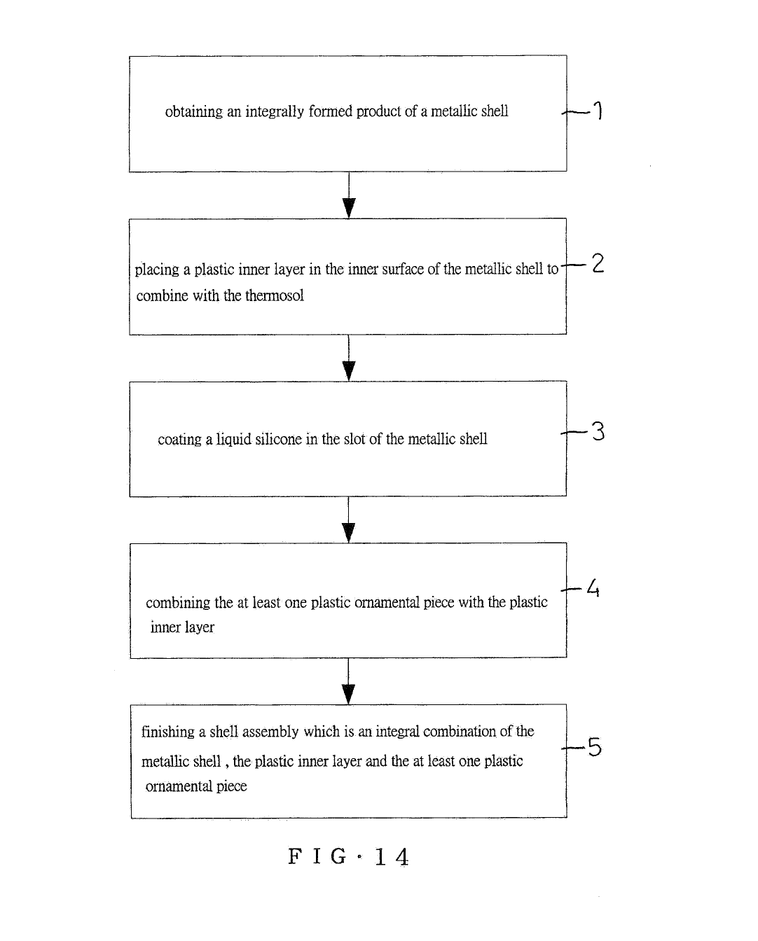

Referring to FIG. 14 with reference to 1-13, a method for manufacturing a shell assembly in accordance with the preferred embodiment of the present invention comprises a first step 1, a second step 2, a third step 3, a fourth step 4 and a fifth step 5.

The first step 1 includes placing a metallic plate 30 in a lower die 10 which has a periphery provided with an annular groove 12 for mounting a separation washer 13 which has a top higher than a top plane of the lower die 10, placing the metallic plate 30 on the top of the separation washer 13, moving an upper die 20 downward to apply a determined pressure on the metallic plate 30, heating the lower die 10 and the upper die 20 by a heating device to reach a proper temperature so as to deform the metallic plate 30, delivering a high pressure gas through the upper die 20 to blow and press the metallic plate 30 into a lower die cavity 11 of the lower die so as to form a metallic shell, moving the upper die upward to open the lower die, removing the metallic shell from the lower die cavity 11 of the lower die, and trimming the metallic shell to remove a residual part so as to obtain an integrally formed product of the metallic shell 31.

The second step 2 includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, coating a glue on the at least one worked portion of the metallic shell, coating a thermosol on the inner surface of the metallic shell, and placing a plastic inner layer in the inner surface of the metallic shell to combine with the thermosol.

The third step 3 includes coating a liquid silicone in the at least one slot of the metallic shell.

The fourth step 4 includes forming a plurality of through holes in the at least one slot of the metallic shell, forming a plurality of apertures in the plastic inner layer, inserting a plurality of connecting legs of at least one plastic ornamental piece through the through holes 33 of the at least one slot of the metallic shell into the apertures 41 of the plastic inner layer 40 and letting the connecting legs of the at least one plastic ornamental piece protrude outward from the apertures 41 of the plastic inner layer, and heating and pressing the connecting legs of the at least one plastic ornamental piece by a heating mold to integrally combine the at least one plastic ornamental piece with the plastic inner layer 40.

The fifth step 5 includes finishing a shell assembly which is an integral combination of the metallic shell, the plastic inner layer and the at least one plastic ornamental piece.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A shell assembly comprising:
a metallic shell, a plastic inner layer, and at least one plastic ornamental piece;
wherein:
the metallic shell is provided with at least one slot, the metallic shell has an inner surface provided with at least one protruding arcuate face aligning with the at least one slot, the metallic shell is processed by an anodizing treatment, the at least one protruding arcuate face of the metallic shell is processed by a CNC working procedure to have an insulating function, the inner surface of the metallic shell is provided with at least one worked portion which is processed by an etching process or a laser engraving working procedure, the at least one worked portion of the metallic shell is coated with a glue, and the at least one slot of the metallic shell is provided with a plurality of through holes equally spaced from each other;
the plastic inner layer is provided with a plurality of apertures aligning with the through holes of the metallic shell, the inner surface of the metallic shell is coated with a thermosol, and the plastic inner layer is placed in the inner surface of the metallic shell and is combined with the thermosol; and
the at least one plastic ornamental piece is provided with a plurality of connecting legs aligning with the through holes of the metallic shell, the at least one plastic ornamental piece is coated with a liquid silicone, the connecting legs of the at least one plastic ornamental piece are inserted through the through holes of the at least one slot of the metallic shell into the apertures of the plastic inner layer and slightly protrude outward from the apertures of the plastic inner layer, and the connecting legs of the at least one plastic ornamental piece are heated and pressed by a heating mold so that the at least one plastic ornamental piece is combined integrally with the plastic inner layer.

2. The shell assembly of claim 1, wherein the metallic shell is integrally formed by a thermoplastic molding process.

3. The shell assembly of claim 1, wherein the plastic inner layer and the at least one plastic ornamental piece are made of plastics.

4. A method for manufacturing a shell assembly, comprising:
a first step, a second step, a third step, a fourth step and a fifth step;
wherein:
the first step includes placing a metallic plate in a lower die which has a periphery provided with an annular groove for mounting a separation washer which has a top higher than a top plane of the lower die, placing the metallic plate on the top of the separation washer, moving an upper die downward to apply a determined pressure on the metallic plate, heating the lower die and the upper die by a heating device to reach a proper temperature so as to deform the metallic plate, delivering a high pressure gas through the upper die to blow and press the metallic plate into a lower die cavity of the lower die so as to form a metallic shell, moving the upper die upward to open the lower die, removing the metallic shell from the lower die cavity of the lower die, and trimming the metallic shell to remove a residual part so as to obtain an integrally formed product of the metallic shell;
the second step includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, coating a glue on the at least one worked portion of the metallic shell, coating a thermosol on the inner surface of the metallic shell, and placing a plastic inner layer in the inner surface of the metallic shell to combine with the thermosol;
the third step includes coating a liquid silicone in the at least one slot of the metallic shell;
the fourth step includes forming a plurality of through holes in the at least one slot of the metallic shell, forming a plurality of apertures in the plastic inner layer, inserting a plurality of connecting legs of at least one plastic ornamental piece through the through holes of the at least one slot of the metallic shell into the apertures of the plastic inner layer and letting the connecting legs of the at least one plastic ornamental piece protrude outward from the apertures of the plastic inner layer, and heating and pressing the connecting legs of the at least one plastic ornamental piece by a heating mold to integrally combine the at least one plastic ornamental piece with the plastic inner layer; and
the fifth step includes finishing a shell assembly which is an integral combination of the metallic shell, the plastic inner layer and the at least one plastic ornamental piece.

5. The method of claim 4, wherein the metallic shell is integrally formed by a thermoplastic molding process.

6. The method of claim 4, wherein the plastic inner layer and the at least one plastic ornamental piece are made of plastics.
